(19) United States
(12) Patent Application Publication
(10) Pub. No.: US 2025/0249680 A1
(43) Pub. Date: Aug. 7, 2025

(54) LIQUID DROPLET EJECTING APPARATUS

(71) Applicant: BROTHER KOGYO KABUSHIKI KAISHA, Nagoya (JP)

(72) Inventor: ITTA YAMADA, Nagoya (JP)

(21) Appl. No.: 19/039,000

(22) Filed: Jan. 28, 2025

(30) Foreign Application Priority Data
Feb. 2, 2024 (JP) 2024-014902

(51) Int. Cl. B41J 2/045; B41J 2/155

(52) U.S. Cl. CPC B41J 2/04573; B41J 2/04526; B41J 2/04551; B41J 2/0457; B41J 2/04581; B41J 2/04588; B41J 2/155; B41J 2202/21

(57) ABSTRACT

There is provided a liquid droplet ejecting apparatus including: a conveyor configured to convey a print medium in a conveying direction; a line head having a plurality of nozzles which is disposed side by side in the conveying direction and a crossing direction crossing the conveying direction and each of which is configured to eject a liquid droplet to the print medium; and a controller configured to increase an ejection velocity of the liquid droplet by an upstream nozzle, of the plurality of nozzles, located upstream in the conveying direction of a downstream nozzle being a part of the plurality of nozzles, to be higher than the ejection velocity of the liquid droplet by the downstream nozzle, or to delay an ejection timing of the liquid droplet by the upstream nozzle.

### REFERENCE TO RELATED APPLICATIONS

This application claims priority from Japanese Patent Application No. 2024-014902 filed on Feb. 2, 2024. The entire content of the priority application is incorporated herein by reference.

### BACKGROUND ART

In ink-jet printers, a vortex flow is known to be generated by airflow caused by ejection of an ink droplet from a nozzle, and the ejected ink droplet is affected by the vortex flow, causing a deviation in the landing position of the ink droplet.

### SUMMARY

Although there is a known technique which reduces the deviation in landing of the ink droplet by reducing the vortex flow occurring in a case where the ink droplet is ejected from the nozzle, the known technique does not consider the influence of conveyance airflow caused by conveyance of a print medium. Therefore, reducing of the deviation in landing of the ink droplet is not sufficient.

In view of the above, the present disclosure aims to provide a liquid droplet ejecting apparatus capable of reducing deviation in landing of a liquid droplet.

According to a first aspect of the present disclosure, there is provided a liquid droplet ejecting apparatus including:
a conveyor configured to convey a print medium in a conveying direction;
a line head having a plurality of nozzles which is disposed side by side in the conveying direction and a crossing direction crossing the conveying direction and each of which is configured to eject a liquid droplet to the print medium; and
a controller configured to increase an ejection velocity of the liquid droplet by an upstream nozzle, of the plurality of nozzles, located upstream in the conveying direction of a downstream nozzle being a part of the plurality of nozzles, to be higher than the ejection velocity of the liquid droplet by the downstream nozzle, or to delay an ejection timing of the liquid droplet by the upstream nozzle.

According to a second aspect of the present disclosure, there is provided a liquid droplet ejecting apparatus including:
a conveyor configured to convey a print medium in a conveying direction;
a line head having a plurality of nozzles which is disposed side by side in the conveying direction and a crossing direction crossing the conveying direction and each of which is configured to eject a liquid droplet to the print medium; and
a controller configured to increase an ejection velocity of the liquid droplet by a nozzle, of the plurality of nozzles, located at least one of both ends in the crossing direction to be higher than the ejection velocity of the liquid droplet by a remaining nozzle of the plurality of nozzles.

According to the present disclosure, the deviation in landing of a liquid droplet can be reduced by increasing an ejection velocity of the liquid droplet from an upstream nozzle, which is relatively susceptible to influence of external disturbances such as a conveyance airflow, etc., occurring during the conveyance of a print medium, than a downstream nozzle.

According to the present disclosure, a liquid droplet ejecting apparatus capable of reducing the deviation in landing of the liquid droplet can be provided.

### BRIEF DESCRIPTION OF DRAWINGS

FIG. 1 is a plan view depicting a liquid droplet ejecting apparatus.

FIG. 2 is a cross-sectional view depicting a configuration of an ejecting head of FIG. 1.

FIG. 3 is a block diagram depicting an example of components of a printing apparatus for which the liquid droplet ejecting apparatus of FIG. 1 is provided.

FIG. 4 is a bottom view depicting a configuration of a head bar.

FIG. 5 is a bottom view depicting a manner in which nozzles are located in the ejecting head.

FIG. 6 is a diagram depicting a relationship between each of head bars and application voltages to actuators corresponding to nozzles in each of the head bars.

FIG. 7 is a diagram depicting a relationship between each of ejecting heads and application voltages to actuators corresponding to nozzles in each of the ejecting heads.

FIG. 8 is a diagram depicting a relationship between each of the nozzles and application voltages to actuators corresponding to nozzles.

FIG. 9 depicts, change in the application voltage in a head bar which is used in a case where a head bar which is not used is present among the head bars.

FIG. 10 is a partially enlarged view of FIG. 4.

FIG. 11 is a diagram depicting application voltages with respect to actuators corresponding to nozzles located in an overlap area, and application voltages to actuators corresponding to nozzles located in a non-overlap area.

FIG. 12 depicts a side wind caused by conveyance airflow.

FIG. 13 is a diagram depicting applications voltage in each of the ejecting heads of the head bar.

FIG. 14 is a diagram depicting application voltage to be increased with respect to the actuator, per each nozzle.

FIG. 15 is a diagram describing the occurrence of negative pressure and upstream-oriented airflow in a case of a high gap.

FIG. 16A is a diagram depicting that a distance between a platen and a nozzle surface is the high gap, and FIG. 16B is a diagram depicting that the distance is a low gap.

FIG. 17 is a diagram depicting application voltages to an upstream ejecting head and application voltages to a downstream ejecting head during printing under the high gap.

Upper part of FIG. 18 is a diagram depicting a driving waveform for an actuator corresponding to a downstream nozzle, and lower part of FIG. 18 is a diagram depicting a driving waveform for an actuator corresponding to an upstream nozzle.

### DESCRIPTION

A liquid droplet ejecting apparatus according to an embodiment of the present disclosure will be described below with reference to the drawings. The liquid droplet ejecting apparatus described below is merely an embodiment of the present disclosure. Therefore, the present disclosure is not limited to the following embodiment, and additions, deletions, and changes are possible within the scope not deviating from the gist of the present disclosure.

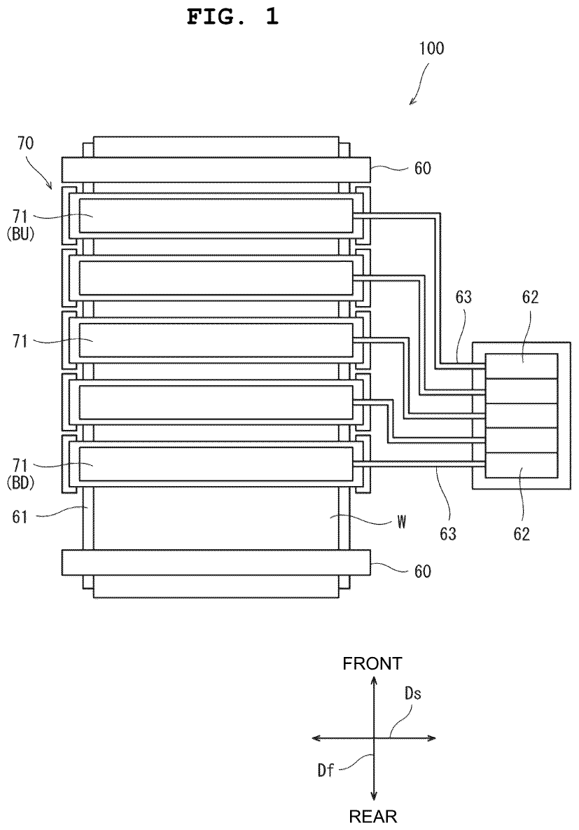

FIG. 1 is a plan view depicting a liquid droplet ejecting apparatus 100 according to an embodiment. The liquid droplet ejecting apparatus 100 in the present embodiment is of the line head system. In FIG. 1, directions orthogonal to each other are designated as a conveying direction Df and an orthogonal direction Ds. In the present embodiment, the conveying direction Df is an example of a conveying direction of a print medium W, and the orthogonal direction Ds is an example of a crossing direction crossing the conveying direction.

As depicted in FIG. 1, the liquid droplet ejecting apparatus 100 includes a line head 70, a pair of conveying rollers 60, a platen 61, a plurality of storage tanks 62, and a plurality of tubes 63.

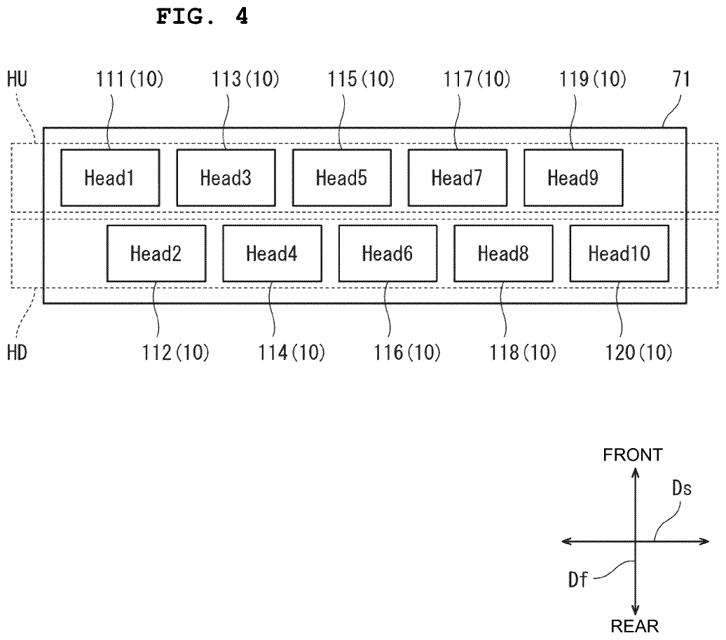

The line head 70 has five head bars 71 as an example of a plurality of head bars 71. The head bars 71 are disposed each corresponding to the color of the ink. The head bars 71 are disposed side by side at substantially equal distances in the conveying direction Df. Each of the head bars 71 extends in the crossing direction Ds. Each of the head bars 71 includes a plurality of ejecting heads 10 (FIG. 4) which will be described later.

The platen 61 supports the print medium W from below. For example, the platen 61 has a predetermined thickness and is constructed of a rectangular plate member of which longitudinal direction is the conveying direction Df.

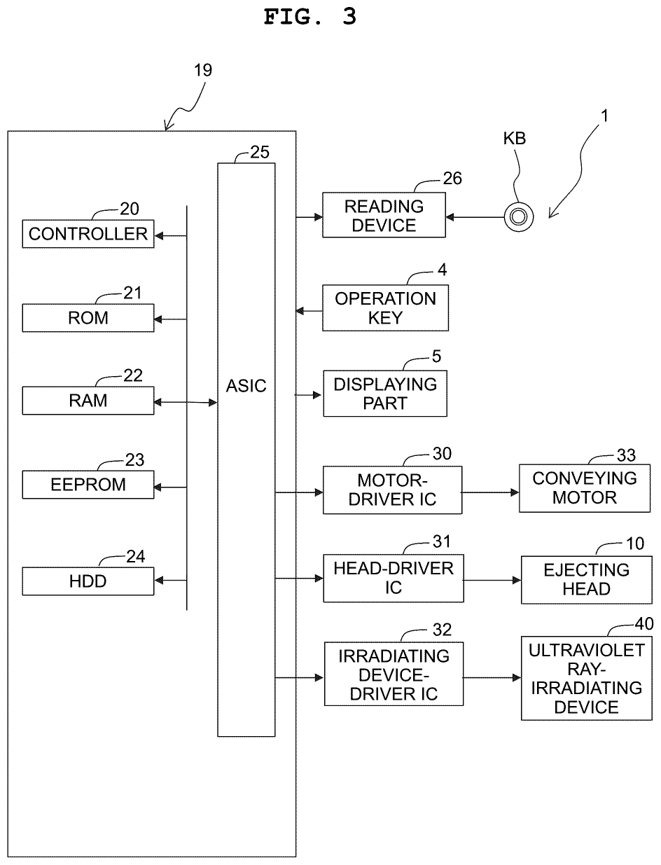

The pair of conveying rollers 60 extends in the crossing direction Ds. The dimension of each of the conveying rollers 60 in the crossing direction Ds is greater than the dimension of the print medium W in the crossing direction Ds. One of the pair of conveying rollers 60 is connected to a conveying motor 33 (FIG. 3) which will be described later, and is disposed on one side in the conveying direction Df with respect to the platen 61 (for example, in front of the platen 61). The other of the pair of conveying rollers 60 is disposed on the other side in the conveying direction Df with respect to the platen 61 (for example, behind the platen 61). In a case where the conveying motor 33 is driven, the conveying rollers 60 rotate, and the print medium W on the platen 61 is conveyed in the conveying direction Df. Note that in the present embodiment, the print medium W is conveyed from the front to the rear. That is, the front is the upstream of the conveying direction, and the rear is the downstream of the conveying direction.

Ink is stored in each of the plurality of storage tanks 62. The plurality of storage tanks 62 is provided for kinds of the ink, respectively. The storage tanks 62 are provided as, for example, five storage tanks 62, and store black, yellow, cyan, magenta and white inks, respectively. A color image is printed by ejecting ink droplets of the four color inks, which are black, yellow, cyan and magenta inks, to the print medium W. Further, a base is formed by ejecting the white ink droplets of the white ink to the print medium W.

The plurality of tubes 63 are provided each corresponding to one of the plurality of storage tanks 62. The tube 63 connects the storing tank 62 with the plurality of ejecting heads 10 disposed in the head bar 71.

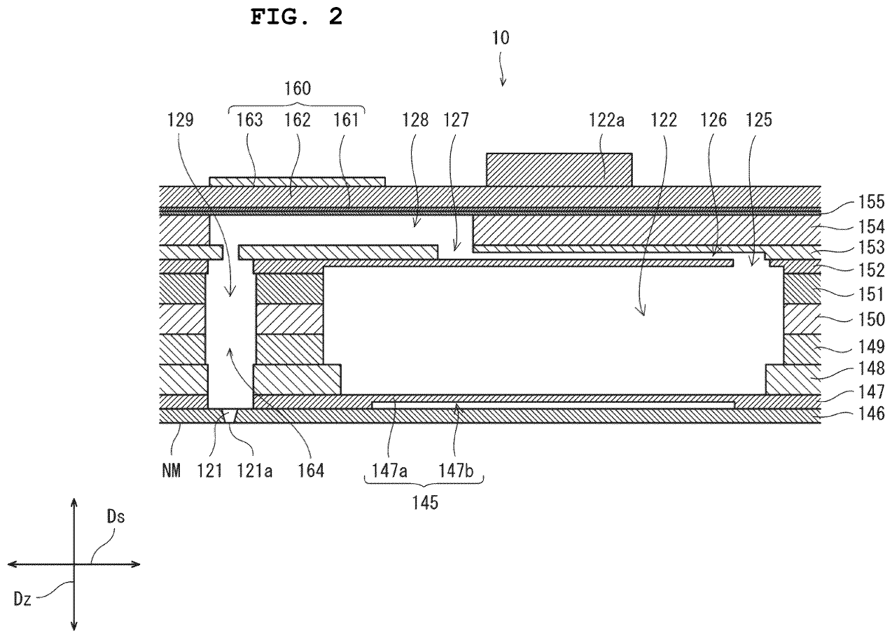

Next, the detailed configuration of the ejecting head 10 will be described. FIG. 2 is a cross-sectional view of each of the ejecting heads 10. As the ejecting head 10, for example, an ink-jet head which ejects an ink droplet of, for example, ultraviolet ray-curable ink as a liquid droplet can be adopted. However, the ejecting head 10 is not limited to the above-described head.

As depicted in FIG. 2, the ejecting head 10 has a plurality of nozzles 121 configured to eject ink droplets by using the ink from the storage tank 62. The ejecting head 10 has a stacked structure of a channel-forming body and a volume-changing part. An ink channel is formed inside the channel-forming body, and a plurality of nozzle holes 121a is open in a nozzle surface NW which is the lower surface of the channel-forming body. Further, the volume changing part is driven to change the volume of the ink channel. At this time, the meniscus vibrates in each of the nozzle holes 121a, thereby ejecting the ink.

The above-described channel-forming body of the ejecting head 10 is a stacked structure of a plurality of plates, and the volume-changing part includes a vibration plate 155 and an actuator (piezoelectric element) 160. A common electrode 161, which will be described later, is connected to the top of the vibration plate 155.

The above-described plurality of plates is stacked, in the following order from bottom up, a nozzle plate 146, a spacer plate 147, a first channel plate 148, a second channel plate 149, a third channel plate 150, a fourth channel plate 151, a fifth channel plate 152, a sixth channel plate 153, and a seventh channel plate 154 which are included in the plurality of plates.

The respective plates have holes and grooves of various sizes formed therein. Inside the channel-forming body in which the respective plates are stacked, the holes and grooves of various sizes are combined to form the plurality of nozzles 121, a plurality of individual channels 164, and a manifold 122, as the ink channel.

The plurality of nozzles 121 are formed to penetrate the nozzle plate 146 in a stacking direction of the plurality of plates. In the nozzle surface NM of the nozzle plate 146, the plurality of nozzle holes 121a being forward ends of the plurality of nozzles 121 is located side by side in the conveying direction Df to form a nozzle row.

The manifold 122 supplies the ink to a pressure chamber 128 to which ejection pressure is to be applied. The manifold 122 extends in the conveying direction Df, and is connected to one end of each of the plurality of individual channels 164. In other words, the manifold 122 functions as a common channel for the ink. The manifold 122 is defined by through holes penetrating the first channel plate 148 to the fourth channel plate 151 in the stacking direction and a recessed portion recessed from the lower surface of the fifth channel plate 152 which are overlapped in the stacking direction.

The nozzle plate 146 is disposed below the spacer plate 147. The spacer plate 147 is formed of, for example, a stainless steel material. The spacer plate 147 has a recessed portion 145 in which a thinned portion defining a damper portion 147a, and a damper space 147b are formed by being recessed from a surface, of the spacer plate 147, which is close to the nozzle plate 146, in a thickness direction of the spacer plate 147 by, for example, the half etching. As a result, the damper space 147b is defined as a buffer space between the manifold 122 and the nozzle plate 146.

A supply port 122a communicates with the manifold 122. The supply port 122a is formed, for example, in a tubular shape and is located at one end in the conveying direction Df. The manifold 122 and the supply port 122a are connected by a non-illustrated channel.

Each of the plurality of individual channels 164 is connected to the manifold 122. Each of the plurality of individual channels 164 has an upstream end connected to the manifold 122 and a downstream end connected to the base end of a corresponding nozzle 121 of the plurality of nozzles 121. Each of the individual channels 164 is defined by a first communication hole 125, a supply throttle channel 126 which is an individual throttle channel, a second communication hole 127, a pressure chamber 128, and a descender 129, and these components are located in this order.

The first communication hole 125 has a lower end connected to an upper end of the manifold 122, extends upward in the stacking direction from the manifold 122, and penetrates an upper portion in the fifth channel plate 152 in the stacking direction.

An upstream end of the supply throttle channel 126 is connected to the upper end of the first communication hole 125. The supply throttle channel 126 is formed, for example, by the half etching, and is defined by a recess recessed from the lower surface of the sixth channel plate 153. Further, an upstream end of the second communication hole 127 is connected to a downstream end of the supply throttle channel 126, extends upward in the stacking direction from the supply throttle channel 126, and is formed penetrating the sixth channel plate 153 in the stacking direction.

The pressure chamber 128 has an upstream end connected to a downstream end of the second communication hole 127. The pressure chamber 128 is formed to penetrate the seventh channel plate 154 in the stacking direction.

The descender 129 is formed to penetrate the spacer plate 147, the first channel plate 148, the second channel plate 149, the third channel plate 150, the fourth channel plate 151, the fifth channel plate 152, and the sixth channel plate 153 in the stacking direction. The descender 129 has an upstream end connected to a downstream end of the pressure chamber 128 and a downstream end connected to the base end of the nozzle 121. The nozzle 121 overlaps with the descender 129, for example, in the stacking direction, and is located in the center of the descender 129 in a width direction of the descender 129.

The vibration plate 155 is stacked on the seventh channel plate 154 and covers the opening in the upper end of the pressure chamber 128.

The actuator 160 includes a common electrode 161, a piezoelectric layer 162, and an individual electrode 163 which are disposed in this order. The common electrode 161 covers the entire surface of the vibration plate 155. The piezoelectric layer 162 covers the entire surface of the common electrode 161. The individual electrode 163 is disposed as a plurality of individual electrodes 163 each of which corresponds to a corresponding pressure chamber 128 of a plurality of pressure chambers 128, and are disposed on the piezoelectric layer 162. One actuator 160 is constructed of one individual electrode 163, the common electrode 161, and a portion of the piezoelectric layer 162 sandwiched between the common electrode 161 and the individual electrode 163.

The plurality of individual electrodes 163 is electrically connected to a head-driver IC. The head-driver IC receives a control signal from a controller 20 (FIG. 3), generates a drive signal (voltage signal), and applies the drive signal to each of the plurality of individual electrodes 163. In contrast, the common electrode 161 is always held at the ground potential. In this configuration, an active portion of the piezoelectric layer 162 expands and contracts in a plane direction in response to the drive signal together with the common electrode 161 and the individual electrode 163. In response to this, the vibration plate 155 cooperatively deforms, and deforms in a direction to increase or decrease the volume of the pressure chamber 128. As a result, ejection pressure is applied to the pressure chamber 128 so as to eject an ink droplet from the nozzle 121.

In the ejection head 10, the ink flows into the manifold 122 via the supply port 122a, then the ink flows from the manifold 122 into the supply throttle channel 126 via the first communication hole 125, and then the ink flows from the supply throttle channel 126 into the pressure chamber 128 via the second communication hole 127. The ink then flows through the descender 129 and into the nozzle 121. In a case where the ejection pressure is applied to the pressure chamber 128 by the actuator 160, an ink droplet is ejected from the nozzle hole 121a to the print medium W.

FIG. 3 is a block diagram depicting an example of components of a printing apparatus 1 for which the liquid droplet ejecting apparatus 100 of FIG. 1 is provided.

As depicted in FIG. 3, the printing apparatus 1 includes an operation key 4, a display part 5, a controller unit 19, a reading device 26, a motor-driver IC 30, a head-driver IC 31, an irradiating device-driver IC 32, a conveying motor 33, and an ultraviolet ray irradiating device 40. Note that the conveying motor 33 and the conveying roller 60 correspond to a “conveyor”.

The operation key 4 receives input of operation by a user. The displaying part 5 is constructed of, for example, a touch panel, and displays predetermined information. A part of the displaying part 5 also functions as the operation key 4. The controller unit 19 realizes a print function based on input from the operation key 4 or input from the outside via a non-illustrated communication interface, and also controls the display of the displaying part 5.

The controller unit 19 has the controller 20 constructed of a CPU, a plurality of memories (ROM 21, RAM 22, EEPROM 23, HDD 24), and an ASIC 25. The controller 20 is connected to each of the above-described memories and controls the motor-driver IC 30, the head-driver IC 31, the irradiating device-driver IC 32, the displaying part 5, and the reading device 26.

The controller 20 executes various functions by executing a predetermined processing program stored in the ROM 21. The controller 20 may be mounted in the controller unit 19 as one processor, or as a plurality of processors which cooperates with each other. The processing program is read by a reading device 26 from a computer-readable magneto-optical disc, etc., or a storage medium KB such as a USB flash memory, etc., and is stored in the ROM 21. The RAM 22 stores image data received from the outside, an arithmetic result of the controller 20, etc. The EEPROM 23 stores a variety of kinds of initial setting information input by the user. The HDD 24 stores a variety of kinds of information.

The motor-driver IC 30, the head-driver IC 31, and the irradiating device-driver IC 32 are connected to the ASIC 25. In a case where the controller 20 receives a print job from the user, the controller 20 outputs a print instruction to the ASIC 25 based on the processing program. The ASIC 25 drives the motor-driver IC 30, the head-driver IC 31, and the irradiating device-driver IC 32 based on the print instruction. The controller 20 rotates the conveying rollers 60 to move the print medium W on the platen 61 in the conveying direction Df, by driving the conveying motor 33 with the motor-driver IC 30.

The controller 20 converts the image data obtained from an external device, etc., into ejection data for ejecting ink droplets to the print medium W. The controller 20 causes the ejecting head 10 to eject ink droplets, with the head-driver IC 31, based on the converted ejection data. Further, the controller 20 causes a light-emitting diode chip included in the ultraviolet ray-irradiating device 40 to emit an ultraviolet ray, with the irradiating device-driver IC 32. Note that the ultraviolet ray-irradiating device 40 is disposed between one head bar 71 and another head bar 71, included in the head bars 71, in the conveying direction Df.

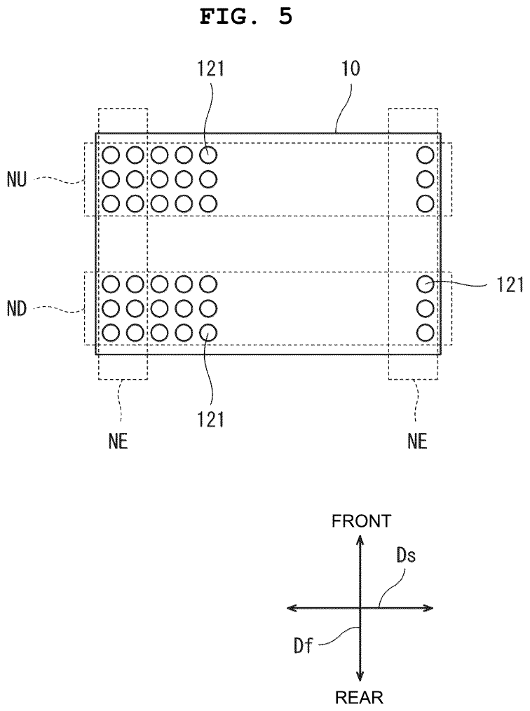

FIG. 4 is a bottom view depicting the configuration of each of the head bars 71. FIG. 5 is a bottom view depicting the manner in which the plurality of nozzles 121 are located in the ejecting head 10.

As depicted in FIG. 4, ten ejecting heads 10 are disposed in each of the head bars 71 as an example of the plurality of ejecting heads 10. Among the ten ejecting heads 10, five ejecting heads 10 are disposed on the upstream side in the conveying direction Df (i.e., on the front side), and the remaining five ejecting heads 10 are disposed on the downstream side in the conveying direction Df (i.e., on the rear side). The five ejecting heads 10 disposed on the upstream side in the conveying direction Df are referred to as upstream ejecting heads HU. The upstream ejecting heads HU include ejecting heads 111, 113, 115, 117, and 119 as the ejecting heads 10. On the other hand, the five ejecting heads 10 disposed on the downstream side in the conveying direction Df are referred to as downstream ejecting heads HD. The downstream ejecting heads HD include ejecting heads 112, 114, 116, 118, and 120 as the ejecting heads 10. The respective upstream ejecting heads HU are disposed substantially at equal distances. The respective downstream ejecting heads HD are disposed substantially at equal distances, and each of the downstream ejecting heads HD is disposed while being shifted by a predetermined distance in the crossing direction Ds with respect to one of the upstream ejecting heads HU. That is, the plurality of ejecting heads 10 in the head bar 71 is disposed in a staggered manner in the crossing direction Ds. Note, however, that in the case where the plurality of ejecting heads 10 is configured to construct three or more rows in the conveying direction Df, the following is satisfactory. That is, the downstream ejecting head HD may be one ejecting head 10 among the plurality of ejecting heads 10 and the upstream ejecting head HU may be an ejecting head 10 located upstream in the conveying direction Df relative to the downstream ejecting head HD.

As depicted in FIG. 5, each of the ejecting heads 10 includes a plurality of nozzles 121. The respective nozzles 121 are located regularly in the ejecting head 10. Specifically, the respective nozzles 121 are located substantially at equal distances in both the conveying direction Df and the crossing direction Ds. Nozzles 121 included in the plurality of nozzles 121 and located on the upstream side in the conveying direction Df are each referred to as an upstream nozzle NU, and nozzles 121 included in the plurality of nozzles 121 and located on the downstream side in the conveying direction Df are each referred to as a downstream nozzle ND.

Note, however, that the classification between the upstream nozzle NU and the downstream nozzle ND is not limited to the example in FIG. 5, and the following is satisfactory. That is, the downstream nozzle ND may be a nozzle 121 as a part of the plurality of nozzles 121, and the upstream nozzle NU may be a nozzle 121 located upstream of the downstream nozzle ND in the conveying direction Df. Further, among the plurality of nozzles 121, nozzles 121 located on both sides in the crossing direction Ds are defined as end part nozzles NE. The end part nozzles NE may include nozzles 121 which are positioned at an end-most location on each of the both sides in the crossing direction Ds and which form a row, or the end part nozzles NE may include nozzles 121 which form a row or a plurality of rows at the end-most location and a location inside the end-most location on each of the both sides in in the crossing direction Ds. Note that in FIG. 5, the nozzles 121 located between the upstream nozzles NU and the downstream nozzles ND are omitted.

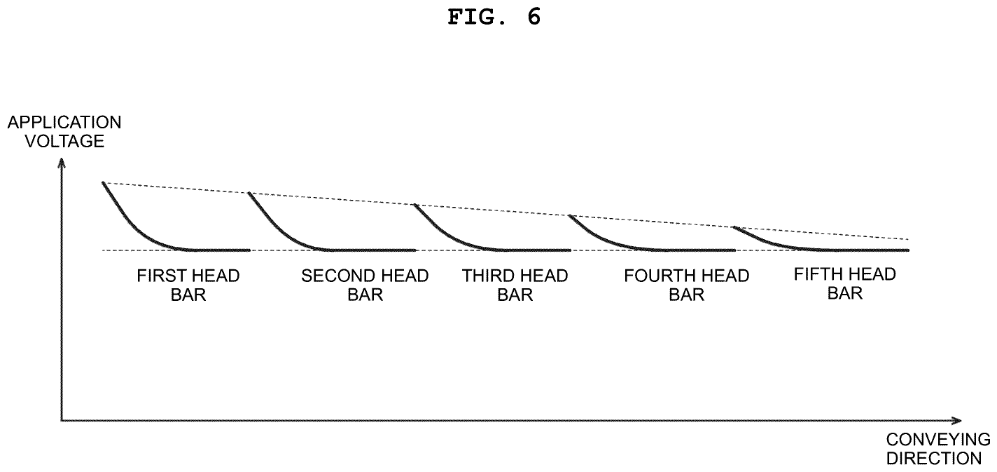

FIG. 6 is a diagram depicting the relationship between each of the head bars 71 and application voltages (driving voltages) to the actuators 160 corresponding to the nozzles 121 in each of the head bars 71. In FIG. 6, a first head bar is an upstream head bar BU, which is a head bar 71 included in the plurality of head bars 71 and located on the upstream side in the conveying direction Df, and a fifth head bar is a downstream head bar BD, which is a head bar 71 included in the plurality of head bars 71 and located on the downstream side in the conveying direction Df. Note, however, that the following is satisfactory. That is, the downstream head bar BD may be one head bar 71 among the plurality of head bars 71, and the upstream head bar BU may be a head bar 71 located upstream in the conveying direction Df of the downstream head bar BD.

In the present embodiment, the controller 20 increases the ejection velocity of the ink droplet by the upstream nozzle NU located upstream in the conveying direction Df of the downstream nozzle ND to be higher than the ejection velocity of the ink droplet by the downstream nozzle ND. Specifically, the controller 20 increases the application voltage to the actuator 160 corresponding to the upstream nozzle NU to be higher than the application voltage to the actuator 160 corresponding to the downstream nozzle ND, thereby increasing the ejection velocity of the ink droplet by the upstream nozzle NU. The amount by which the application voltage is to be increased is set in advance according to a conveying velocity of the print medium W, etc. In the present embodiment, the increase in the application voltage will be described in units of head bars, units of ejecting heads, and units of nozzles.

In a case where the magnitude of the application voltages to the actuators 160 is viewed broadly head bar 71 by head bar 71, an aspect depicted in FIG. 6 is obtained. As depicted in FIG. 6, in a case where the magnitude of the application voltages to the actuators 160 is viewed in units of head bars, the application voltage to the actuator 160 in each of the head bars 71 is increased by the controller 20 from the downstream side to the upstream side. That is, the application voltage in the ejection head 10 of the upstream head bar BU is increased by the controller 20 to be higher than the application voltage in the ejection head 10 of the downstream head bar BD. As a result, the ejection velocity of the ink droplets by the ejection head 10 of the upstream head bar BU is increased to be higher than the ejection velocity of the ink droplets by the ejection head 10 of the downstream head bar BD. This is in consideration of the fact that the upstream head bar BU is more susceptible to the influence of the conveyance airflow than the downstream head bar BD.

Further, in a case where the magnitude of the application voltages to the actuators 160 is viewed with respect to adjacent two head bars 71 among the head bars 71, the application voltage to the actuator 160 corresponding to the upstream-most nozzle 121 in the upstream head bar 71 is increased by the controller 20 to be higher than the application voltage to the actuator 160 corresponding to the upstream-most nozzle 121 in the downstream head bar 71. This is because the upstream-most nozzle 121 in the upstream head bar 71 is relatively more susceptible to the influence of the conveyance airflow, while the nozzle 121 in the above-described head bar 71 located downstream of the upstream head bar 71 is less susceptible to the influence of the conveyance airflow.

Furthermore, in a case where the magnitude of the application voltages to the actuators 160 is viewed with respect to the two adjacent head bars 71, the application voltage to the actuator 160 corresponding to the upstream-most nozzle 121 in the downstream head bar 71 is increased by the controller 20 to be higher than the application voltage to the actuator 160 corresponding to a downstream-most nozzle 121 in the upstream head bar 71. This is to take into consideration the generation of a draft between the head bars 71 due to the conveyance airflow.

Note that instead of executing the process of increasing the ejection velocity of the ink droplet as described above, the controller 20 may delay the ejection timing of the ink droplet by delaying an input timing of the driving waveform to the actuator 160. By delaying the input timing of the driving waveform to the actuator 160, the ejection timing of the ink droplet is delayed relative to a timing specified by the image data obtained from the external device, etc. For example, the controller 20 can delay the input timing of the driving waveform to the actuator 160 by adjusting the ejection data generated based on the image data. Alternatively, the controller 20 may execute both the process of increasing the ejection velocity of the ink droplet and the process of delaying the ejection timing. Note that the same applies to aspects which will be described below.

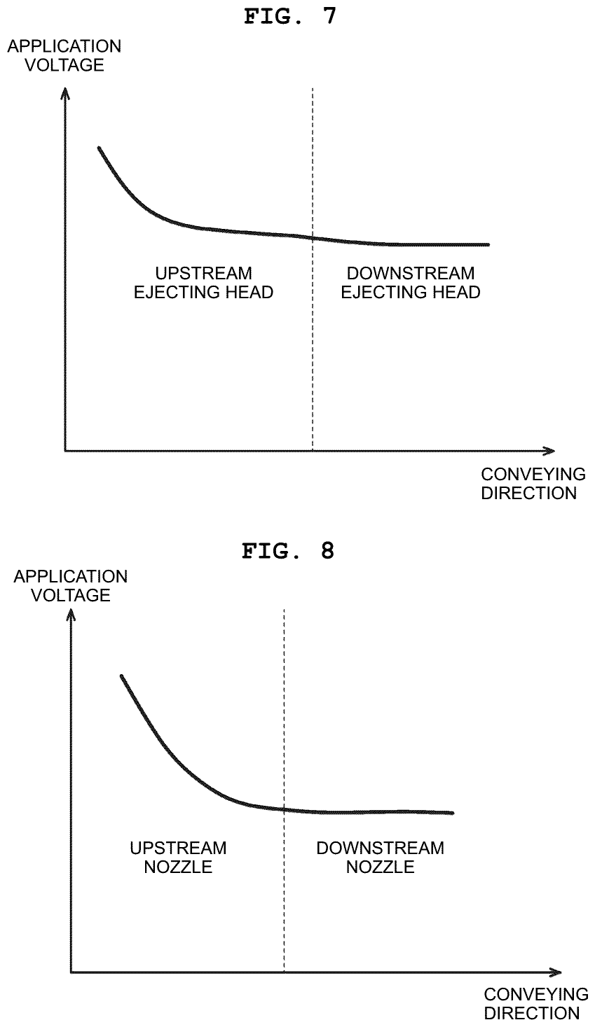

FIG. 7 is a diagram depicting the relationship between each of the ejecting heads 10 and the application voltages to the actuators 160 corresponding to the nozzles 121 in each of the ejecting heads 10.

In FIG. 6, the magnitude of the application voltages to the actuators 160 is broadly depicted in units of head bars, whereas in a case where the magnitude of the application voltages is viewed in a narrower sense in units of ejecting heads, an aspect depicted in FIG. 7 is obtained as a result. As depicted in FIG. 7, the application voltages to the actuators 160 in each of the ejecting heads 10 is increased from the downstream side to the upstream side by the controller 20. That is, the application voltages with respect to the actuators 160 corresponding to the nozzles 121 in the upstream ejecting head HU is increased higher than the application voltages to the actuators 160 corresponding to the nozzles 121 in the downstream ejecting head HD. This takes into consideration the fact that the nozzles 121 in the upstream ejecting head HU are more susceptible to the influence of the conveyance airflow than the nozzles 121 in the downstream ejecting head HD.

FIG. 8 is a diagram depicting the relationship between each of the nozzles 121 and the application voltage to the actuator 160 corresponding to each of the nozzles 121.

In FIG. 7, the magnitude of the application voltages with respect to the actuators 160 is depicted in units of ejecting heads, whereas in a case where the magnitude of the application voltages is viewed more narrowly in units of nozzles, an aspect depicted in FIG. 8 is obtained as a result. As depicted in FIG. 8, the application voltage to the actuator 160 corresponding to each of the nozzles 121 is increased from the downstream side to the upstream side by the controller 20. That is, the application voltage to the actuator 160 corresponding to the upstream nozzle NU is increased to be higher than the application voltage to the actuator 160 corresponding to the downstream nozzle ND. This takes into consideration the fact that the upstream nozzle NU is more susceptible to the influence of the conveyance airflow than the downstream nozzle ND.

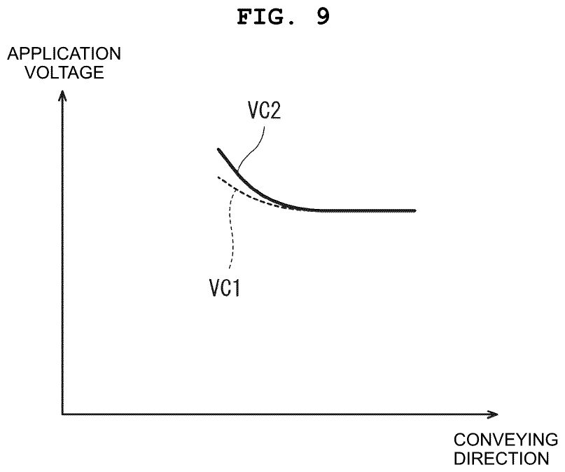

Next, FIG. 9 depicts, the change in the application voltage in a head bar 71 which is used among the plurality of head bars 71, in a case where a head bar 71 which is not used is present among the plurality of head bars 71.

As described above, since each of the head bars 71 corresponds to one of the colors of inks, a head bar 71 which is not used might be present, in some cases, depending on the aspect of printing. Therefore, the positional relationship between the upstream head bar BU and the downstream head bar BD might change. In a case where a head bar 71 which is not used in the printing is present among the plurality of head bars 71 in such a manner, the controller 20 determines the above-described upstream head bar BU and downstream head bar BD from the head bars 71 which are used. For example, in FIG. 6, in a case where the head bar 71 related to the first head bar, the head bar 71 related to the second head bar, and the head bar 71 related to the third head bar are not used, the controller 20 determines the head bar 71 related to the fourth head bar as the upstream head bar BU, and determines the head bar 71 related to the fifth head bar as the downstream head bar BD.

In this case, as depicted in FIG. 9, the controller 20 increases application voltages VC1 in the head bar 71 being the fourth head bar in the case where the first head bar, second head bar, and third head bar are used, so that the application voltages VC1 become application voltages VC2 in the head bar 71 being the fourth head bar which is the upstream head bar BU. Note that the application voltages, in the application voltages VC2, which correspond to the downstream side in the conveying direction Df is approximately the same as the application voltages, in the application voltages VC1, which correspond to the downstream side in the conveying direction Df.

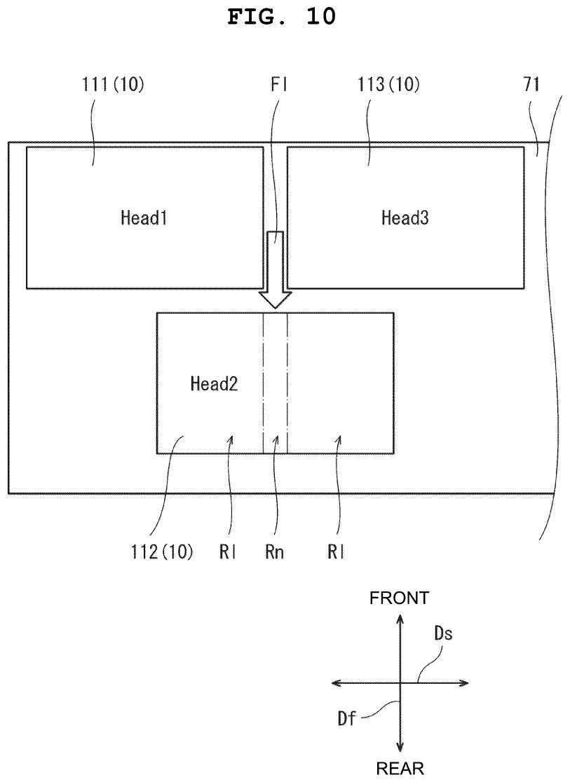

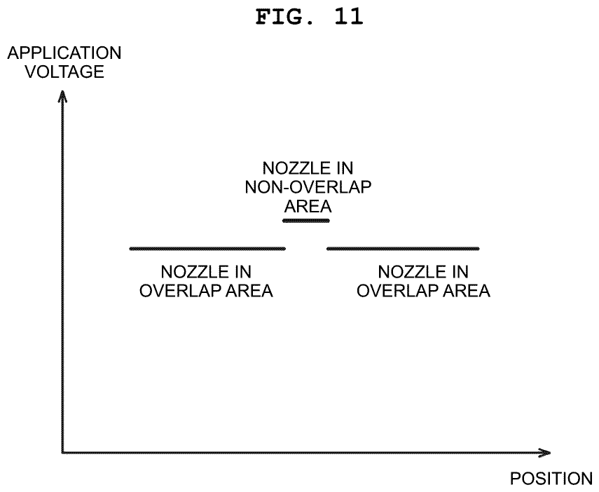

FIG. 10 is a partially enlarged view of FIG. 4. FIG. 11 is a diagram depicting application voltages to the actuators 160 corresponding to the nozzles 121 in an overlap area and application voltages to the actuators 160 corresponding to the nozzles 121 in a non-overlap area.

As described above, each of the downstream ejecting heads HD is disposed to be shifted, at the predetermined distance, with respect to one of the upstream ejecting heads HU in the crossing direction Ds, thereby disposing the plurality of ejecting heads 10 in a staggered manner in the crossing direction Ds. As a result, each of the downstream ejecting heads HD has an area which does not overlap, in the conveying direction Df, with any of the upstream ejecting heads HU. To describe this point using the example depicted in FIG. 10, the ejecting head 112, which is the downstream ejecting head HD, has areas (overlap areas) RI, RI which overlap, in the conveying direction Df, with the ejecting heads 111 and 113, respectively, which are the upstream ejecting heads HU, and an area (non-overlap area) Rn which does not overlap, in the conveying direction Df, with the ejecting heads 111 and 113. The area Rn is an area between the area RI as one of the overlap areas and another area RI as the other of the overlap areas in the crossing direction Ds.

As described above, the ejecting head 111 and the ejecting head 113, which are the upstream ejecting heads HU, are disposed at the equal distances, and thus a draft F1 due to the conveying airflow occurs between the ejecting head 111 and the ejecting head 113. Therefore, the area Rn of the ejecting head 112 is relatively affected by the draft F1 more than the areas RI. In this regard, as depicted in FIG. 11, the controller 20 increases the ejection velocity of the ink droplet by the nozzle 121 in the area (non-overlap area) Rn, of the downstream ejecting head HD, which does not overlap in the conveying direction Df with the upstream ejecting heads HU, to be higher than the ejection velocity of the ink droplet by the nozzle 121 in the areas (overlap areas) RI of the downstream ejecting head HD each of which overlaps in the conveying direction Df with the upstream ejecting head HU. Note that, similarly to the ejecting head 112 among the downstream ejecting heads HD, the ejection velocity of the ink droplet by the nozzle 121 of the area Rn in each of the remaining ejecting heads 114, 116, 118, and 120 is also increased by the controller 20.

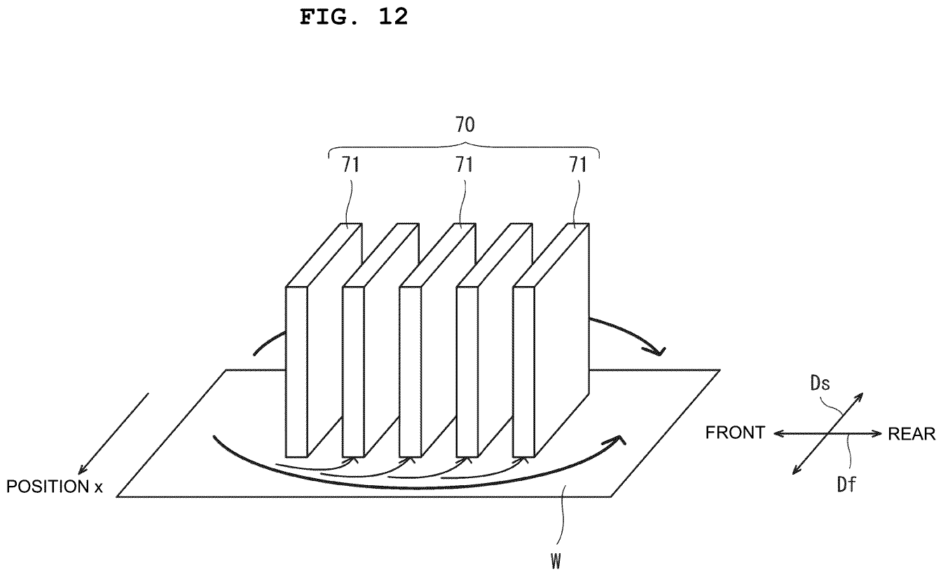

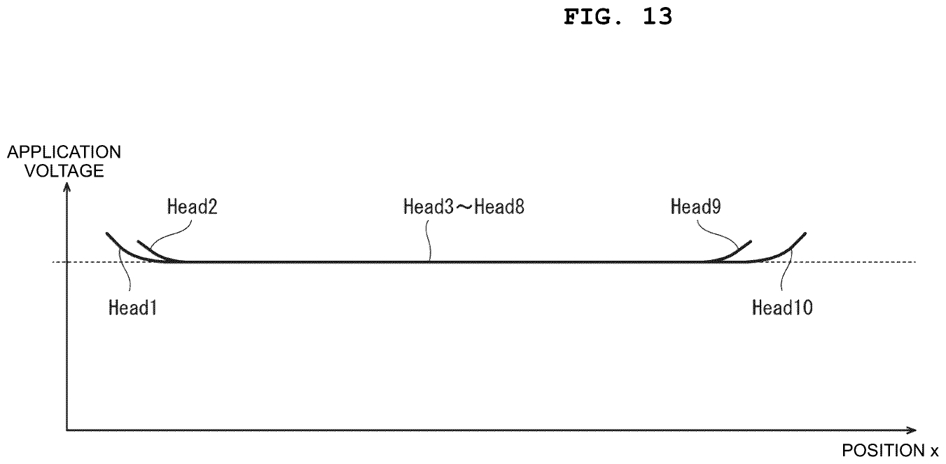

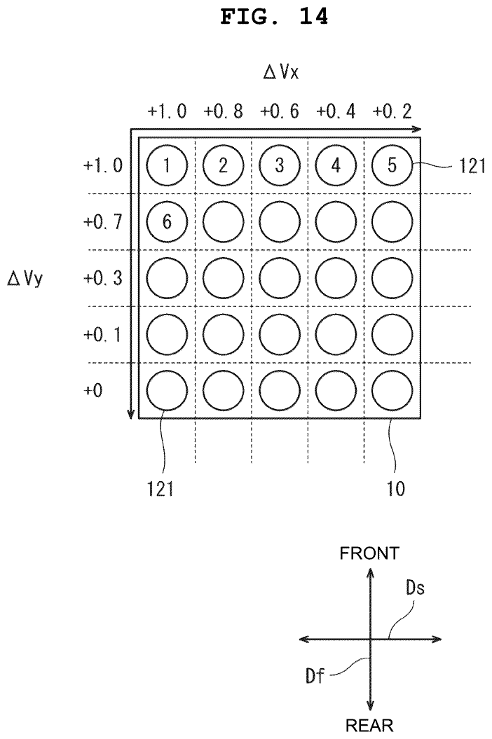

FIG. 12 is a diagram depicting a side wind caused by the conveyance airflow. FIG. 13 is a diagram depicting the application voltage in each of the ejecting heads 10 of the head bar 71.

Due to the conveyance airflow which occurs in a case where the print medium W is conveyed in the conveying direction Df, airflow (hereinafter, referred to as side wind, or a conveyance airflow flowing in the crossing direction) along the crossing direction Ds may occur in some cases, as depicted in FIG. 12. In each of the head bars 71, the nozzles 121 included in the plurality of nozzles 121 and located on the both sides in the crossing direction Ds are relatively affected by the side wind more than the remaining nozzles 121.

In this regard, the controller 20 increases the ejection velocity, of the ink droplet by each of the nozzle 121 included in the plurality of nozzles 121 and located on the both sides in the crossing direction Ds, to be higher than the ejection velocity of the ink droplet by each of the remaining nozzles 121 included in the plurality of nozzles 121. Specifically, the controller 20 increases the ejection velocity of the ink droplet by each of the end part nozzles NE on one side in the crossing direction Ds described above with reference to FIG. 5 (i.e., the end part nozzles NE on the outer side) among the plurality of nozzles 121 in the ejecting head 111 which is disposed at an end-most position in the crossing direction Ds to be higher than the ejection velocity of the ink droplet by each of the remaining nozzles 121 in the crossing direction Ds in the ejecting head 111. In this case, as depicted in FIG. 13, the application voltages to a predetermined number of nozzles 121 among the nozzles 121 which are located on the inner side, in the crossing direction Ds, with respect to the end part nozzle NE on the one side in the crossing direction Ds is lowered while being gradually decreased, and the application voltages to the remaining nozzles 121 in the crossing direction Ds except for those nozzles 121 are kept constant.

Similarly, the controller 20 increases the ejection velocity of the ink droplet by each of the end part nozzles NE on the other side in the crossing direction Ds (i.e., the end part nozzles NE on the outer side) among the plurality of nozzles 121 in the ejecting head 120 which is disposed at the end-most position in the crossing direction Ds to be higher than the ejection velocity of the ink droplet by each of the remaining nozzles 121 in the crossing direction Ds. In this case, as depicted in FIG. 13, the application voltages to a predetermined number of nozzles 121 among the nozzles 121 which are located on the inner side, in the crossing direction Ds, with respect to the end part nozzle NE on the other side is lowered while being gradually decreased, and the application voltages with respect to the remaining nozzles 121 in the crossing direction Ds except for those nozzles 121 is kept constant.

Further, the application voltage in the ejecting head 112 is changed by the controller 20 in the same manner as the above-described ejecting head 111, except that the maximum value of the application voltage is lower than the maximum value of the application voltage in the ejecting head 111. Similarly, the application voltage in the ejecting head 119 is changed by the controller 20 in the same manner as the above-described ejecting head 120, except that the maximum value of the application voltage is lower than the maximum value of the application voltage in the ejecting head 120. Note that, with respect to each of the ejecting heads 113 to 118 in the head bar 71, the application voltages are all made constant only regarding the plurality of nozzles 121 which are located side by side in the crossing direction Ds.

Next, FIG. 14 is a diagram depicting application voltage which is to be increased with respect to the actuator 160, per each nozzle 121. In FIG. 14, the application voltage is determined by the controller 20, taking into consideration the conveyance airflow (hereinafter referred to as “vertical wind”) flowing in the conveying direction Df and the above-described side wind. The determination, by the controller 20, regarding the application voltage will be described in detail below. Note that in FIG. 14, for the purpose of identifying each of the nozzles 121, a number is inserted in a circle indicating each of the nozzles 121, as the address of each of the nozzles 121.

As depicted in FIG. 14, in each of the ejecting heads 10, a first change amount ΔVx by which the application voltage to the actuator 160 is to be increased based on the influence of the side wind, and a second change amount ΔVy by which the application voltage to the actuator 160 is to be increased based on the influence of the vertical wind are set in advance with respect to each of the nozzles 121. Note that the first change amount ΔVx can be set in any manner in accordance with the magnitude of the side wind caused due to the conveying velocity of the print medium W, etc., and the second change amount ΔVy can be set in any manner in accordance with the magnitude of the vertical wind caused due to the conveying velocity of the print medium W, etc.

The controller 20 executes, per each actuator 160, a process of increasing the application voltage to the actuator 160 by the change amount which is greater one of the first change amount ΔVx and the second change amount ΔVy. Further, the controller 20 executes, for each actuator 160, a process of changing an ejection timing of the ink droplet by the nozzle 121 corresponding to the actuator 160, in accordance with the difference between the first change amount ΔVx and the second change amount ΔVy.

An example depicted in FIG. 14 will be described. For example, with respect to an actuator 160 corresponding to a nozzle 121 of address 1, both the first change amount ΔVx and the second change amount ΔVy are +1.0 V. Therefore, the controller 20 increases the application voltage by 1.0 V with respect to the actuator 160 corresponding to the nozzle 121 of address 1. In contrast, for example, with respect to an actuator 160 corresponding to a nozzle 121 of address 6, the first change amount ΔVx is +1.0 V, whereas the second change amount ΔVy is +0.7 V. Therefore, the controller 20 increases the application voltage by 1.0 V with respect to the actuator 160 corresponding to the nozzle 121 of address 6. However, this increase in the application voltage of 1.0 V is higher by 0.3 V than the second change amount ΔVy (i.e., +0.7 V), resulting in a voltage value which overly considers the influence of the vertical wind. As a result, the landing position of the ink droplet is deviated in the conveying direction Df. In this regard, the controller 20 executes the process of changing the ejection timing of the ink droplet by the nozzle 121, in accordance with the difference between the first change amount ΔVx and the second change amount ΔVy. In this situation, in a case where the difference between the first change amount ΔVx and the second change amount ΔVy is relatively small, an ejection timing which is slightly delayed from the initial ejection timing is adopted, whereas in a case where the difference is relatively large, an ejection timing which is significantly delayed from the initial ejection timing is adopted.

Note that an aspect by which the controller 20 determines the application voltage for each nozzle 121 is not limited to the aspect described above. For example, the controller 20 may execute a process of increasing the application voltage to the actuator 160 by the first change amount ΔVx for each actuator 161, and then change the ejection timing of the ink droplet by the nozzle 121 corresponding to the actuator 160 based on the difference between the first change amount ΔVx and the second change amount ΔVy.

Specifically, for example, in a case where the first change amount ΔVx is smaller than the second change amount ΔVy like the case of address 2 of FIG. 14, the increasing amount (that is, the first change amount ΔVx) is not sufficient to remove the influence of the vertical wind, and the landing position of the ink droplet shifts to the downstream in the conveying direction Df. Therefore, the controller 20 delays the ejection timing of the ink droplet from the nozzle 121 of the address 2 to shift the landing position of the ink droplet upstream in the conveying direction Df.

In a case where the first change amount ΔVx is greater than the second change amount ΔVy like the case of address 6 of FIG. 14, the increasing amount (that is, the first change amount ΔVx) is too much in view of the amount of the influence of the vertical wind, and the landing position of the ink droplet shifts to the upstream in the conveying direction Df. Therefore, the controller 20 advances the ejection timing of the ink droplet from the nozzle 121 of the address 6 to shift the landing position of the ink droplet downstream in the conveying direction Df.

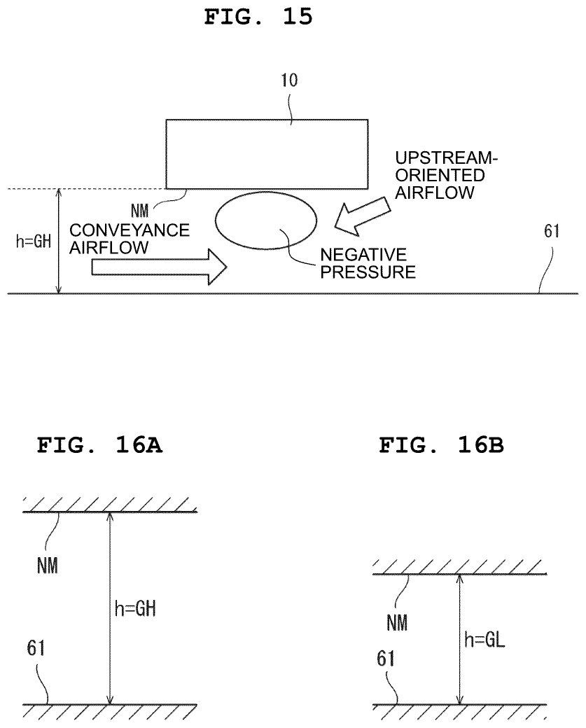

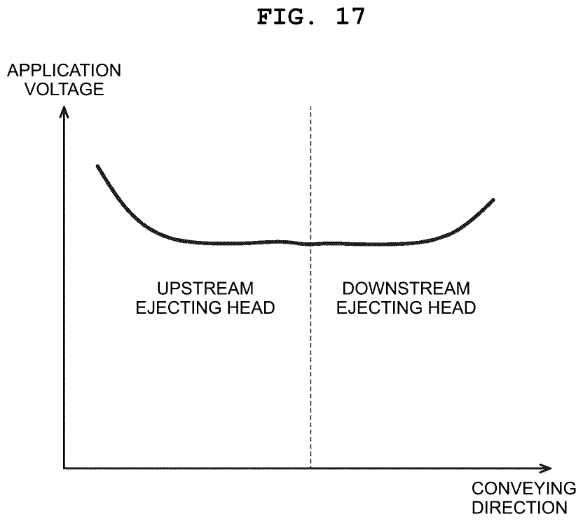

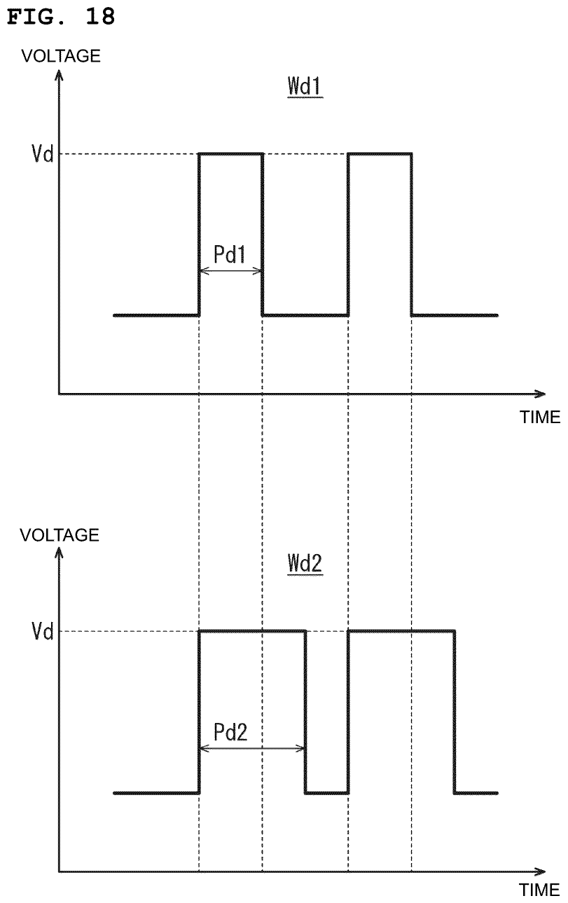

Next, FIG. 15 is a diagram describing the generation of negative pressure and upstream-oriented airflow in a case where the distance between the platen 61 and the nozzle surface NW is a high gap. FIG. 16A is a diagram depicting that the distance between the platen 61 and the nozzle surface NM is the high gap, and FIG. 16B is a diagram depicting that the distance is a low gap. FIG. 17 is a diagram depicting application voltage in the upstream ejecting head HU and application voltage in the downstream ejecting head HD during printing in the high gap.

As depicted in FIG. 16A, a distance in a case where a distance h between the platen 61 and the nozzle surface NM is the longest is a high gap GH. Further, as depicted in FIG. 16B, a distance in a case where the distance h between the platen 61 and the nozzle surface NM is the shortest is a low gap GL. The high gap GH is, for example, 18 mm. The low gap GL is, for example, 2 mm. A print mode in a case where the distance h is the high gap GH is a high gap-print mode, and a print mode in a case where the distance h is the low gap GL is a low gap-print mode. The print job includes information instructing the high gap-print mode in which the printing is performed at the high gap GH and information instructing the low gap-print mode in which the printing is performed at the low gap GL.

In a case where the high gap-print mode is executed, as depicted in FIG. 15, the conveyance airflow passes through an area below the ejecting head 10, thereby generating negative pressure in an area between the ejecting head 10 the area therebelow. Therefore, upstream-oriented airflow is generated. The upstream-oriented airflow is oriented toward a location on the upstream side from a location on the downstream side in the conveying direction Df of the ejecting head 10. In this regard, in a case where the print mode is the high gap-print mode, the controller 20 increases the ejection velocity of the ink droplet by the nozzle 121 included in the plurality of nozzles 121 and located on the downstream side in the conveying direction Df, to be higher than the ejection velocity of the ink droplet by the nozzle 121 included in the plurality of nozzles 121 and located on the upstream side in the conveying direction Df. Specifically, as depicted in FIG. 17, the controller 20 sets the application voltages to the actuators 160 corresponding to the nozzles 121 in the upstream ejecting head HU in a similar manner as in FIG. 7 described above. On the other hand, with respect to the downstream ejecting head HD, unlike the manner depicted in FIG. 7 described above, the controller 20 increases the application voltages to the actuators 160 corresponding to the nozzles 121 located on the downstream side in the conveying direction Df to be higher than the application voltages to the actuators 160 corresponding to the nozzles 121 located on the upstream side in the conveying direction Df. This makes the ejection velocity of the ink droplet by the nozzle 121 located on the downstream side in the conveying direction Df higher than the ejection velocity of the ink droplet by the nozzle 121 located on the upstream side in the conveying direction Df.

Here, as described above, in a case where a base is formed on the print medium W by white ink droplets of the white ink, the controller 20 does not execute the process of increasing the ejection velocity and the process of delaying the ejection timing. Further, even in a case where the base is formed on the print medium W, ruled line deviation might occur in an end part, of the base, on the downstream side in the conveying direction Df. In this regard, in a case where the base is formed, and with respect to a part, of the print medium W, which is located on the downstream side in the conveying direction Df, the controller 20 increases the ejection velocity of the ink droplet by the nozzle 121 included in the plurality of nozzles and located on the upstream side in the conveying direction Df to be higher than the ejection velocity of the ink droplet by the nozzle 121 included in the plurality of nozzles 121 and located on the downstream side in the conveying direction Df. The phrase “part, of the print medium W, which is located on the downstream side in the conveying direction Df” is, for example, a part, of the print medium W, in which the last dot is to be formed in the conveying direction Df.

Next, the upper part of FIG. 18 is a diagram depicting a driving waveform Wd1 for the actuator 160 corresponding to the downstream nozzle ND, and the lower part of FIG. 18 is a diagram depicting a driving waveform Wd2 for the actuator 160 corresponding to the upstream nozzle NU.

As depicted in the upper part of FIG. 18, the driving waveform Wd1 has a pulse width Pd1, and the driving voltage of the driving waveform Wd1 is Vd. On the other hand, as depicted in the lower part of FIG. 18, the driving waveform Wd2 has a pulse width Pd2 greater than the pulse width Pd1, and the driving voltage of the driving waveform Wd2 is the same as the driving voltage Vd of the driving waveform Wd1. The controller 20 controls the actuator 160 of the upstream nozzle NU based on the driving waveform Wd2, based on which the ejection velocity is faster than the ejection velocity based on the driving waveform Wd1 for the actuator 160 of the downstream nozzle ND. In this way, the controller 20 controls the actuator 160 of the upstream nozzle NU using the driving waveform Wd2 in which the pulse width is made great, without increasing the driving voltage.

As described above, according to the liquid droplet ejecting apparatus 100, the deviation in landing of the ink droplet can be reduced by increasing the ejection velocity of the ink droplet by the upstream nozzle NU which is relatively susceptible to the influence of external disturbances such as the conveyance airflow, etc., occurring during the conveyance of the print medium W, as compared to the downstream nozzle ND. That is, in a case where the ejection velocity of the ink droplet is high, a period during which the ink droplet is affected by external disturbances such as the conveyance airflow etc. is short, and thus the deviation in the landing position is small. Further, in a case where the ejection velocity of the ink droplet is high, the energy of the ejection is great, and thus, the trajectory of the ink droplet is less likely to bend even if the ink droplet is affected by the external disturbances such as the conveyance airflow etc. As a result, deviation of the landing position of the ink droplet is small. Note that in a case where the ejection timing of the ink droplet is delayed, although the deviation in the course of the ink droplet toward the downstream side in the conveying direction does not become small, the deviation in landing of the ink droplet becomes small by an extent corresponding to the amount by which the ejection timing is delayed.

Further, in the present embodiment, the controller 20 increases the driving voltage to the actuator 160 of the upstream nozzle NU to be higher than the driving voltage to the actuator 160 of the downstream nozzle ND, thereby increasing the ejection velocity of the ink droplet. In this case, the ejection velocity of the ink droplet can be easily increased.

Furthermore, in the present embodiment, the controller 20 increases the ejection velocity of the ink droplet by the upstream ejecting head HU to be higher than the ejection velocity of the ink droplet by the downstream ejecting head HD. With this, the deviation in landing of the ink droplet can be reduced in each of the plurality of ejecting heads 10 disposed in the staggered manner.

Moreover, in the present embodiment, the controller 20 increases the ejection velocity of the ink droplet by the nozzle 121 in the area Rn, in the downstream ejecting head HD, which does not overlap in the conveying direction Df with the upstream ejecting head HU, to be higher than the ejection velocity of the ink droplet by the nozzle 121 in the area RI, in the downstream ejecting head HD, which overlaps in the conveying direction Df with the upstream ejecting head HU. In this regard, the area Rn is susceptible to the influence of external disturbances such as the conveyance airflow, etc. According to the above-described configuration, the deviation in landing of the ink droplet can be reduced by increasing the ejection velocity of the ink droplet by the nozzle 121 in the area Rn.

Further, in the present embodiment, the controller 20 increases the ejection velocity of the ink droplet by the ejecting heads 10 of the upstream head bar BU to be higher than the ejection velocity by the ejecting heads 10 of the downstream head bar BD. With this, the deviation in landing of the ink droplet of the ejecting heads 10 in the plurality of head bars 71 disposed side by side in the conveying direction Df can be reduced.

Furthermore, in the present embodiment, in a case where a head bar 71 which is not used in the printing is present among the plurality of head bars 71, the controller 20 determines the upstream head bar BU and the downstream head bar BD among the head bars 71 which are used. In this case, the head bar 71 for which the reduction of the deviation in landing of the ink droplet is not required can be excluded from the control.

Moreover, in the present embodiment, the controller 20 increases the ejection velocity of the ink droplet by each of the end part nozzles NE included in the plurality of nozzles 121 and located on the one side described above with reference to FIG. 5 (i.e., outer end part nozzles NE) in the ejecting head 111 which is disposed at the end-most position in the crossing direction Ds to be higher than the ejection velocity of the ink droplet by each of the remaining nozzles 121 in the crossing direction Ds in the ejecting head 111. Similarly, the controller 20 increases the ejection velocity of the ink droplet by each of the end part nozzles NE on the other side (i.e., outer end part nozzles NE) among the plurality of nozzles 121 in the ejecting head 120 which is disposed at the end-most position in the crossing direction Ds to be higher than the ejection velocity of the ink droplet by each of the remaining nozzles 121 in the crossing direction Ds in the ejecting head 120. In this case, the deviation in landing of the ink droplet can be reduced by increasing the ejection velocity of the ink droplet by the nozzle 121 which is relatively susceptible to the influence of the side wind.

Further, in the present embodiment, the controller 20 executes, for each actuator 160, the process of increasing the application voltage to the actuator 160 by the change amount which is greater one of the first change amount ΔVx and the second change amount ΔVy. Furthermore, the controller 20 executes, for each actuator 160, the process of changing the ejection timing of the ink droplet by the nozzle 121 corresponding to the actuator 160, in accordance with the difference between the first change amount ΔVx and the second change amount ΔVy. In this case, ejection control which takes into account both the vertical wind and the side wind can be realized. With this, the accuracy of reducing the deviation in landing of the ink droplet can be further improved.

Moreover, in the present embodiment, in a case where the print mode is the high gap-print mode, the controller 20 increases the ejection velocity of the ink droplet by the nozzle 121, included in the plurality of nozzles 121 and located on the downstream side in the conveying direction Df, to be higher than the ejection velocity of the ink droplet by the nozzle 121 included in the plurality of nozzles 121 and located on the upstream side in the conveying direction Df. In this case, by increasing the ejection velocity of the ink droplet by the downstream nozzle 121 in the conveying direction Df which is susceptible to the influence of the airflow caused by the above-described negative pressure more than the upstream nozzle 121 in the conveying direction Df, etc., the deviation in landing of the ink droplet during the printing at the high gap can be reduced.

Further, in the present embodiment, in a case where the base is formed on the print medium W by the white ink droplets, the controller 20 does not execute the process of increasing the ejection velocity and the process of delaying the ejection timing. In this case, the ejection control in a case where the base, regarding which no particular problem occurs even in a case where the deviation in landing of the ink droplet occurs, can be omitted.

Furthermore, in the present embodiment, in a case where the base is to be formed, the controller 20 increases, with respect to the part, of the print medium W, which is located on the downstream side in the conveying direction Df, the ejection velocity of the ink droplet by the nozzle 121, included in the plurality of nozzles 121 and located on the upstream side in the conveying direction Df to be higher than the ejection velocity of the ink droplet by the nozzle 121 included in the plurality of nozzles 121 and located on the downstream side in the conveying direction Df. In this case, in the case where the base is to be formed, the deviation in landing of the ink droplet in the end part, of the print medium W, which is located on the downstream side in the conveying direction Df can be reduced. With this, the ruled line deviation in the end part, of the base on the print medium W, on the downstream side in the conveying direction Df can be reduced.

Moreover, in the present embodiment, the controller 20 controls the actuator 160 of the upstream nozzle NU based on the driving waveform Wd2 based on which the ejection velocity is faster than the ejection velocity based on the driving waveform Wd1 for the actuator 160 of the downstream nozzle ND. In this case, in a case where the driving voltage is increased with respect to the actuator 160 with high voltage sensitivity, the size of the ejected ink droplet might not be uniform, which might result, for example, in unevenness in the printing regarding the thickness of the ruled lines, etc. According to the above-described configuration, the actuator 160 of the upstream nozzle NU is controlled based on the driving waveform Wd2 without increasing the driving voltage, and thus the thickness of the ruled lines, etc. is likely to be made uniform, and the unevenness in the printing is reduced.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The present disclosure is not limited to the above-described embodiment, and various modifications are possible without departing from the gist of the present disclosure. For example, the present disclosure can be modified as follows.

In the above-described embodiment, in order to increase the ejection velocity of the ink droplet, the temperature of the ink to be ejected by the upstream nozzle NU may be made higher than the temperature of the ink to be ejected by the downstream nozzle ND.

Further, in the above-described embodiment, in a case where the base is formed, the controller 20 increases, with respect to the part, of the print medium W, located on the downstream side in the conveying direction Df, the ejection velocity of the ink droplet by the nozzle 121 included in the plurality of nozzles 121 and located upstream in the conveying direction Df to be higher than the ejection velocity of the ink droplet by the nozzle 121 included in the plurality of nozzles 121 and located on the downstream side in the conveying direction Df. However, the present disclosure is not limited to this; the landing position of the ink droplet with respect to the part of the print medium W located on the downstream side in the conveying direction Df may be controlled by changing the ejection timing.

In the above-described embodiment, the controller 20 may increase the ejection velocity of the ink droplet by the nozzle 121 located in at least the one end part in the crossing direction Ds to be higher than the ejection velocity of the ink droplet by the remaining nozzles of the plurality of nozzles 121, without increasing the ejection velocity of the ink droplet by the nozzle 121, included in the plurality of nozzles 121 and located at the upstream side in the conveying direction Df to be higher than the ejection velocity of the ink droplet by the nozzles 121 included in the plurality of nozzles 121 and located at the downstream side in the conveying direction Df. This aspect is also capable of realizing the ejection control considering the side wind, and capable of reducing the deviation in landing of the ink droplet.

Further, in the above-described embodiment, although the plurality of head bars 71 are included, the number of the head bar 71 may be one. Alternatively, the head bar 71 itself may not be included. Furthermore, although the plurality of ejecting heads 10 are included, the number of the ejecting head 10 may be one.

Moreover, in the above-described embodiment, a color image is printed by ejecting the ink droplets of the four colors which are black, yellow, cyan, and magenta, to the print medium W, and the base is formed by ejecting the white ink droplets to the print medium W. The present disclosure, however, is not limited to this. A configuration of ejecting another ink, such as clear ink, to the print medium W in addition to the above-described inks may be added to the liquid droplet ejecting apparatus 100.

Further, in the above-described embodiment, the print medium W may be a pre-cut print sheet, a roll sheet which is cut in a post-printing process, or cloth, etc.

Furthermore, in the above-described embodiment, each of the downstream ejecting heads HD is disposed to be shifted by the predetermined distance in the crossing direction Ds with respect to one of the upstream ejecting heads HU, resulting in the configuration in which the plurality of ejecting heads 10 are disposed in the staggered manner in the crossing direction Ds. The present disclosure, however, is not limited to this. For example, the position of the ejecting head 112 in the crossing direction Ds may be the same as the position of the ejecting head 111 in the crossing direction Ds. The positional relationship between the ejecting head 114 and the ejecting head 113, the positional relationship between the ejecting head 116 and the ejecting head 115, the positional relationship between the ejecting head 118 and the ejecting head 117, and the positional relationship between the ejecting head 120 and the ejecting head 119 may also be the same as the positional relationship between the ejecting head 112 and the ejecting head 111.

What is claimed is:

1. A liquid droplet ejecting apparatus comprising:
a conveyor configured to convey a print medium in a conveying direction;
a line head having a plurality of nozzles which is disposed side by side in the conveying direction and a crossing direction crossing the conveying direction and each of which is configured to eject a liquid droplet to the print medium; and
a controller configured to increase an ejection velocity of the liquid droplet by an upstream nozzle, of the plurality of nozzles, located upstream in the conveying direction of a downstream nozzle being a part of the plurality of nozzles, to be higher than the ejection velocity of the liquid droplet by the downstream nozzle, or to delay an ejection timing of the liquid droplet by the upstream nozzle.

2. The liquid droplet ejecting apparatus according to claim 1, wherein:
the line head includes a plurality of pressure chambers each of which is provided for one of the plurality of nozzles and a plurality of actuators each of which is configured to apply ejection pressure to one of the plurality of pressure chambers; and
the controller is configured to increase the ejection velocity of the liquid droplet by the upstream nozzle by increasing a driving voltage to an actuator, of the plurality of actuators, corresponding to the upstream nozzle to be higher than a driving voltage to an actuator, of the plurality of actuators, corresponding to the downstream nozzle.

3. The liquid droplet ejecting apparatus according to claim 1, wherein:
the line head has a plurality of ejecting heads disposed in a staggered manner along the crossing direction, the plurality of nozzles being disposed in each of the plurality of ejecting heads; and
the controller is configured to increase the ejection velocity of the liquid droplet by an upstream ejecting head, of the plurality of ejecting heads, located upstream in the conveying direction of a downstream ejecting head being one of the plurality of ejecting heads, to be higher than the ejection velocity of the liquid droplet by the downstream ejecting head, or to delay the ejection timing of the liquid droplet by the upstream ejecting head.

4. The liquid droplet ejecting apparatus according to claim 3, wherein the controller is configured to increase the ejection velocity of the liquid droplet by a nozzle, of the plurality of nozzles, located in a non-overlap area of the downstream ejecting head, to be higher than the ejection velocity of the liquid droplet by a nozzle, of the plurality of nozzles, located in an overlap area of the downstream ejecting head, or to delay the ejection timing of the liquid droplet by the nozzle located in the non-overlap area, the non-overlap area being an area which does not overlap with the upstream ejecting head in the conveying direction and the overlap area being an area which overlaps with the upstream ejecting head in the conveying direction.

5. The liquid droplet ejecting apparatus according to claim 1, wherein:
the line head has a plurality of head bars disposed side by side in the conveying direction, a plurality of ejecting heads in each of which the plurality of nozzles is disposed being disposed side by side at least along the crossing direction in each of the plurality of head bars; and
the controller is configured to increase the ejection velocity of the liquid droplet by the ejecting head in an upstream head bar, of the plurality of head bars, located upstream in the conveying direction of a downstream head bar being one of the plurality of head bars, to be higher than the ejection velocity of the liquid droplet by the ejecting head in the downstream head bar, or to delay the ejection timing of the liquid droplet by the ejecting head in the upstream head bar.

6. The liquid droplet ejecting apparatus according to claim 5, wherein the controller is configured to determine the upstream head bar and the downstream head bar from head bars, of the plurality of head bars, to be used, in a case where a head bar which is not to be used is present among the plurality of head bars.

7. The liquid droplet ejecting apparatus according to claim 1, wherein the controller is configured to increase the ejection velocity of the liquid droplet by each of nozzles, of the plurality of nozzles, located on both sides in the crossing direction to be higher than the ejection velocity of the liquid droplet by a remaining nozzle of the plurality of nozzles.

8. The liquid droplet ejecting apparatus according to claim 2, wherein:
the line head has a plurality of pressure chambers each provided for one of the plurality of nozzles, and a plurality of actuators each configured to apply ejecting pressure to one of the plurality of pressure chambers; and
the controller is configured to execute for each of the plurality of the actuators:
a process of increasing a driving voltage to the actuator by a change amount which is a greater one of a first change amount by which the driving voltage to the actuator is to be increased and which is preset based on a conveyance airflow flowing in the crossing direction, and a second change amount by which the driving voltage to the actuator is to be increased and which is preset based on the conveyance airflow flowing in the conveying direction; and
a process of changing the ejection timing of the liquid droplet by the nozzle corresponding to the actuator, in accordance with a difference between the first change amount and the second change amount.

9. The liquid droplet ejecting apparatus according to claim 2, wherein:
the line head has a plurality of pressure chambers each provided for one of the plurality of nozzles, and a plurality of actuators each configured to apply ejecting pressure to one of the plurality of pressure chambers; and
the controller is configured to execute for each of the plurality of the actuators:
a process of increasing a driving voltage to the actuator by a first change amount which is preset based on a conveyance airflow flowing in the crossing direction; and
a process of changing the ejection timing of the liquid droplet by the nozzle corresponding to the actuator, in accordance with a difference between the first change amount and a second change amount which is preset based on the conveyance airflow flowing in the conveying direction.

10. The liquid droplet ejecting apparatus according to claim 1, further comprising a platen configured to support the print medium, wherein:
the line head has a nozzle surface; and
in a case where a print mode is a high gap-print mode among a low gap-print mode and the high gap-print mode, the controller is configured to increase the ejection velocity of the liquid droplet by a nozzle, of the plurality of nozzles, located on a downstream side in the conveying direction, to be higher than the ejection velocity of the liquid droplet by a nozzle, of the plurality of nozzles, located on an upstream side in the conveying direction, or to delay the ejection timing of the liquid droplet by the nozzle located on the downstream side, the low gap-print mode being a mode in which a distance between the nozzle surface and the platen is a low gap and the high gap printing mode being a mode in which the distance is a high gap greater than the low gap.

11. The liquid droplet ejecting apparatus according to claim 1, wherein the controller is configured not to execute a process of increasing the ejection velocity and a process of delaying the ejection timing in a case where a base is formed on the print medium.

12. The liquid droplet ejecting apparatus according to claim 1, wherein in a case where a base is formed on the print medium, the controller is configured to increase the ejection velocity of the liquid droplet by a nozzle, of the plurality of nozzles, located on an upstream side in the conveying direction, to be higher than the velocity of the liquid droplet by a nozzle, of the plurality of nozzles, located on a downstream side in the conveying direction, or to delay the ejection timing of the liquid droplet by the nozzle located on the upstream side in the conveying direction, with respect to a part, of the print medium, located on the downstream side in the conveying direction.

13. The liquid droplet ejecting apparatus according to claim 1, wherein:
the line head includes a plurality of pressure chambers each provided for one of the plurality of nozzles and a plurality of actuators each configured to apply ejection pressure to one of the plurality of pressure chambers; and
the controller is configured to control an actuator, of the plurality of actuators, corresponding to the upstream nozzle based on a driving waveform based on which the ejection velocity is faster than the ejection velocity based on a driving waveform for an actuator, of the plurality of actuators, corresponding to the downstream nozzle.

14. A liquid droplet ejecting apparatus comprising:
a conveyor configured to convey a print medium in a conveying direction;
a line head having a plurality of nozzles which is disposed side by side in the conveying direction and a crossing direction crossing the conveying direction and each of which is configured to eject a liquid droplet to the print medium; and
a controller configured to increase an ejection velocity of the liquid droplet by a nozzle, of the plurality of nozzles, located at least one of both ends in the crossing direction to be higher than the ejection velocity of the liquid droplet by a remaining nozzle of the plurality of nozzles.
